(19) United States
(12) Patent Application Publication
(10) Pub. No.: US 2017/0088006 A1
(43) Pub. Date: Mar. 30, 2017

(54) HYBRID VEHICLE WITH COMBINED CABIN AND BATTERY COOLING

(71) Applicant: FORD GLOBAL TECHNOLOGIES, LLC, DEARBORN, MI (US)

(72) Inventors: TIMOTHY N. BLATCHLEY, DEARBORN, MI (US); KENNETH J. JACKSON, DEARBORN, MI (US); ANGEL F. PORRAS, DEARBORN, MI (US)

(21) Appl. No.: 14/863,543

(22) Filed: Sep. 24, 2015

(51) Int. Cl. B60L 11/18; B60H 1/32; B60H 1/00

(52) U.S. Cl. CPC B60L 11/1874; B60H 1/00278; B60H 1/00385; B60H 1/00885; B60H 1/323; B60H 2001/3266; B60H 2001/3283

(57) ABSTRACT

Cooling of a battery pack of an electrified vehicle is performed with an optimized energy usage and with minimal impact on cooling of the passenger cabin. The battery is actively cooled by circulating coolant from the battery to a chiller of an air conditioning system when a battery temperature is above a predetermined power-limiting temperature. The battery is passively cooled by circulating coolant from the battery to a radiator when the battery temperature is between a first threshold and the power-limiting temperature and a difference between a battery coolant temperature and an ambient air temperature is greater than a predetermined difference. The battery is actively cooled using the chiller when the battery temperature is between the first threshold and the power-limiting temperature and the difference between the battery coolant temperature and the ambient air temperature is less than the predetermined difference.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to battery cooling in electrified vehicles, and, more specifically, to a liquid-cooled battery with active and passive cooling modes.

When an electrical storage battery (e.g., battery pack) is used to provide power to an electric motor to drive an electrified vehicle (e.g., hybrid electric or full electric), the temperature of the battery can increase when the motor is operating for extended periods of time. The battery pack is usually installed in a relatively small, enclosed space which tends to retain the heat generated. Increases in battery temperature can reduce battery charge or discharge efficiency and impede battery performance. If the battery is not cooled, the power generation, battery life, and fuel economy may suffer.

Passenger vehicles typically have a passenger air conditioning system to actively cool the passenger compartment, including a compressor, a refrigerant line, and a heat exchanger such as an evaporator. One way that high battery temperatures have been addressed is to use at least a portion of the passenger compartment air conditioning system to cool the battery. Because the air conditioning system is used to cool the passenger compartment, the same compressor can be used to cool the battery, with an additional refrigerant line and evaporator. U.S. Pat. No. 7,658,083 discloses a shared cabin/battery cooling system wherein an evaporator core is provided for cooling the battery via air circulated by a battery fan across the evaporator core and the battery.

In order to more effectively cool the battery, liquid cooling systems have been introduced because water has a higher thermal conductivity (can move heat faster) and a higher specific heat capacity (can absorb more heat) than air. The liquid coolant can be circulated through a cold plate in contact with the battery cells to remove the heat. The liquid coolant can convey the heat to a battery chiller which shares the refrigerant of the passenger air conditioning system.

Another trend in passenger air conditioning systems is the use of separately cooled zones (e.g., front seating and rear seating zones) within the passenger cabin. Each zone may have a respective evaporator which is individually coupled to the refrigerant circuit for on-demand cooling of air in the respective zone. In an electrified vehicle with multiple passenger cooling zones, the demand on the shared refrigerant supply subsystem can become large. Increasing the size of shared cooling subsystem components (e.g., compressor, condenser, evaporator) can be undesirable due to losses in efficiency and increases in cost. Thus, it would be desirable to optimize performance of and energy use by the chiller and evaporators to reduce the overall size of the A/C components while balancing cooling system operation to best meet performance targets when the separate cooling sections reach their peak demands.

### SUMMARY OF THE INVENTION

In one aspect of the invention, an electrified vehicle comprises an electric drive adapted to selectably move the vehicle wherein a battery pack provides electrical energy to the electric drive. The battery pack includes a cooling conduit for conveying a liquid coolant. A battery sensor senses a battery temperature. A passive radiator is exposed to an ambient air temperature. A liquid pump pumps the coolant through the cooling conduit. A shared cooling subsystem includes a compressor and a condenser circulating a refrigerant. A main evaporator is selectably coupled to the shared cooling subsystem and is adapted to evaporate refrigerant to cool a passenger cabin of the vehicle. A chiller is selectably coupled to the shared cooling subsystem and is adapted to evaporate refrigerant to cool the coolant. A diverting valve has a first configuration connecting the radiator with the pump and cooling conduit and has a second configuration connecting the chiller with the pump and cooling conduit. A controller provides commands to the valve for selecting one of the configurations. When the battery temperature is between a first threshold temperature and a predetermined power-limiting temperature then the controller commands the first configuration provided that a difference between a battery coolant temperature and the ambient temperature is greater than a predetermined difference. Otherwise (i.e., if the difference is less than the predetermined difference), the controller commands the second configuration. When the battery temperature is greater than the power-limiting temperature then the controller commands the second configuration.

### BRIEF DESCRIPTION OF THE DRAWINGS

FIG. 1 is a block diagram of a conventional electrified vehicle.

FIG. 2 is a block diagram of a prior art cooling system for a passenger cabin and a battery pack of an electrified vehicle.

FIG. 3 is an embodiment of a shared cabin/battery cooling system of the present invention.

FIG. 4 is a graph showing regimes for active and passive battery cooling according to one embodiment of the invention.

FIG. 5 is a flowchart showing an embodiment of a method of the invention.

### DETAILED DESCRIPTION OF PREFERRED EMBODIMENTS

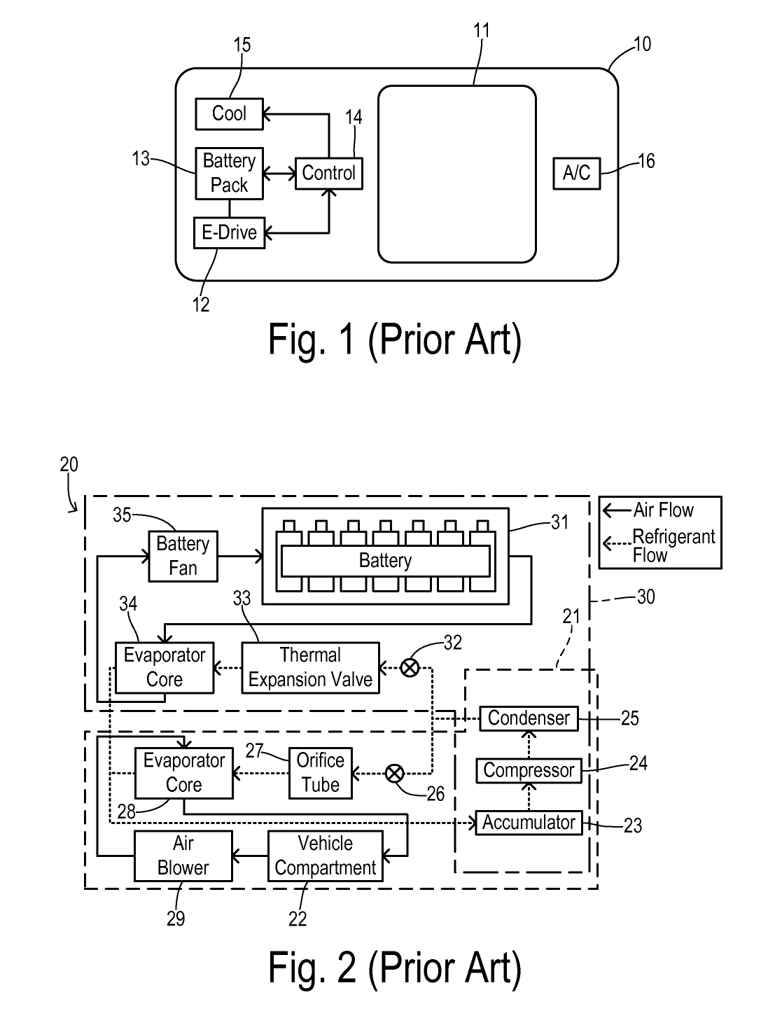

Referring to FIG. 1, an electrified vehicle 10 has a passenger cabin 11. An electric drive 12 (e.g., an inverter-driven traction motor) receives electrical power from a battery pack 13. A controller 14 may include a battery control module for monitoring battery performance (including battery temperature) and a system controller for operating the inverter. A battery cooling system 15 provides a cooling fluid (such as a cooled liquid coolant or a cooled air flow) to battery pack 13 under control of controller 14. Conventional systems have utilized an independent source of cooled air in cooling system 15 and have used a shared cooling system with a passenger A/C system 16 (for either air-cooled or liquid-cooled batteries).

FIG. 2 shows a prior art shared cooling system 20 including a passenger compartment air conditioning (A/C) system 21 capable of cooling passenger compartment 22. The passenger compartment A/C system 21 includes an accumulator 23, a compressor 24, a condenser 25, a shutoff valve 26, an expansion device 27 (such as an electronic expansion valve, temperature expansion valve, or an orifice tube), and an evaporator core 28. These elements are configured to allow a refrigerant to flow between them and operate in a manner known in the art. The flow of refrigerant is determined in part by shutoff valve 26.

Passenger compartment A/C system 21 also includes an air blower 29 operable to facilitate air flow between evaporator core 28 and vehicle compartment 22. Cooling system 20 also includes a battery A/C subsystem 30 capable of cooling a battery 31. Battery A/C subsystem 30 includes a shutoff valve 32, a thermal expansion valve 33, and an evaporator core 34.

Battery A/C subsystem 30 shares accumulator 23, compressor 24, and condenser 25 with the passenger compartment A/C system 21. These elements are configured to allow a refrigerant to flow between them and operate in a manner known in the art. The flow of refrigerant between thermal expansion valve 33 and evaporator core 34 is determined by shutoff valve 32. Battery A/C subsystem 30 also includes a battery fan 35 operable to facilitate air flow between battery 31 and evaporator core 34.

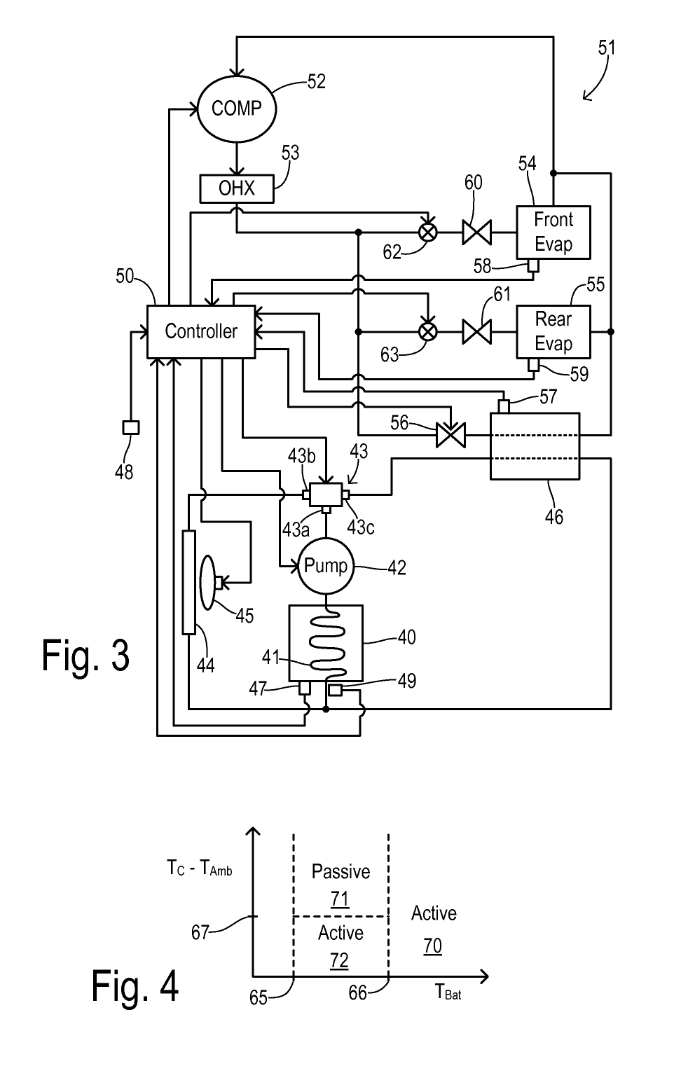

FIG. 3 shows one preferred embodiment of the invention wherein an electrified vehicle having a battery pack 40 for providing electrical energy to an electric drive. Battery 40 includes a cooling conduit 41 for conveying a liquid coolant that absorbs heat from battery 40 and then releases it in one of either an active or passive cooling mode as described below. Conduit 41 may pass through a cold plate which contacts the battery cells, for example.

A coolant pump 42 circulates the coolant through a coolant circuit including a plurality of coolant lines interconnecting conduit 41, a passive battery radiator 44, an active battery chiller 46, and a three-way diverter valve 43. Passive radiator 44 may include a battery fan 45 (or a shared engine cooling fan) for increasing heat removal as coolant passes through battery radiator 44. In the passive cooling mode, diverter valve 43 selectably connects radiator 44 to pump 42 in response to a command signal from a controller circuit 50. Controller 50 may include dedicated logic circuits, programmable gate arrays, or a programmable general-purpose microcontroller, for example. For the passive cooling mode, controller 50 configures valve 43 to couple its outlet 43a to a first inlet 43b and activates pump 42 to circulate the coolant through conduit 41 and radiator 44. Controller 50 may also activate fan 45 while in the passive cooling mode as necessary.

A battery temperature sensor 47 is incorporated with battery pack 40, and an ambient air temperature sensor 48 is mounted to the vehicle where it is exposed to outside air. A sensor 49 measures a temperature of the coolant T_{C} as it exits the battery cold plate. Sensors 47, 48, and 49 are coupled to controller 50 for providing battery temperature and ambient air temperature, respectively, to controller 50 for use in determining when to activate the passive or active cooling modes as described below.

For operating in the active cooling mode, controller 50 configures diverter valve 43 so that outlet 43a is coupled to inlet 43c, thereby directing the flow from pump 42 through conduit 41 and a battery chiller 46. Battery chiller 46 is coupled to a shared cooling subsystem 51 for the passenger cabin.

In shared cooling subsystem 51, a refrigerant is circulated from a compressor 52 to an outside heat exchanger (OHX) 53 operating as a condenser. Refrigerant is applied selectively through respective valves to a front (main) evaporator 54, rear (zone) evaporator 55, and battery chiller 46. Front evaporator 54 is a main evaporator for serving a main zone such as the front passenger cabin or even the entire passenger cabin when no other zone evaporator is present. Battery chiller 46 is selectively coupled to receive refrigerant in the shared cooling subsystem under control of an electronic expansion valve (EXV) 56 that is wired for receiving a control signal from controller 50. EXV 56 is able to be completely closed in order to avoid any consumption by battery chiller 46 when not being used. A sensor 57 is incorporated in battery chiller 46 and is coupled to the controller 50 for providing a chiller outlet refrigerant temperature and refrigerant pressure signal. The sensor is only needed when using an EXV. If EXV 56 is replaced with a TXV and a refrigerant shutoff valve, then sensor 57 is not needed.

For selectively coupling the cabin cooling evaporators to the shared cooling subsystem, either an EXV or a thermostatic expansion valve (TXV) may be used. Thus, TXVs 60 and 61 supply refrigerant to evaporators 54 and 55, respectively, wherein the flow rates through TXVs 60 and 61 automatically adapt to control the superheat of the evaporators in a manner known in the art. In order to completely shut off refrigerant flow in a branch circuit when not needed by evaporators 54 or 55, shutoff supply valves 62 and 63 are connected in series with TXVs 60 and 61 which are controlled by appropriate command signals from controller 50.

In the embodiment shown, each evaporator is individually controlled to consume the appropriate quantity of refrigerant when in use in order to provide the desired superheat for the evaporator or battery chiller. Since battery chiller 46 uses an EXV, a refrigerant temperature and pressure signal from chiller temperature sensor 57 is used by controller 50 in order to set an appropriate flow rate through valve 56 to control the superheat of the chiller. Temperature sensors 58 and 59 may be provided for evaporators 54 and 55, especially if EXVs are substituted for the TXVs. In the preferred embodiment, an EXV is used at least for battery chiller 46 in order to achieve a necessary fine level of control for battery chiller 46 so that the cooling load actually used for the battery does not inadvertently exceed the necessary level because any unnecessary loss of cooling capacity could have a negative impact on cabin cooling.

In operation, the battery cooling system in FIG. 3 uses a minimum of energy as a result of 1) using passive cooling whenever possible and 2) by imposing strict control of refrigerant used by the battery chiller once active cooling becomes required. FIG. 4 illustrates some temperature relationships for defining active and passive cooling regimes used by the cooling system. Selection of active or passive cooling modes may be determined by measured battery temperature T_{Bat} and ambient temperature T_{Amb} according to various temperature thresholds. Another battery-related temperature which may be used in the control algorithm is a measured temperature of the coolant T_{C} as it exits the battery cold plate. A first threshold T₁ shown at 65 defines a lowest battery temperature at which cooling of the battery pack is desired (e.g., about 10° C.). A power-limiting threshold T_{PL} shown at 66 is a function of a lowest battery temperature at which electrical output from the battery pack is negatively impacted to the degree that it becomes worthwhile to expend more energy to reduce the battery temperature (e.g., about 40° C.). For example, threshold T_{PL} may be set a few degrees less than the actual temperature at which the battery performance is affected. Thus, when battery temperature T_{Bat} is greater than power-limiting temperature T_{PL} then the battery cooling system enters the active cooling mode in active regime 70 (i.e., the controller issues command signals to position the diverter valve 43 to circulate liquid coolant from the battery cooling conduit through the battery chiller and to open the expansion valve feeding refrigerant to the battery chiller).

When battery temperature T_{Bat} is greater than first threshold T₁ and less than power-limiting temperature T_{PL} then the selection of the cooling mode depends on a difference between battery coolant temperature T_{C} and ambient air temperature T_{Amb}. This difference is a measure of the ability of the passive radiator to transfer heat to the ambient environment. A difference threshold T_{Diff} shown at 67 represents the temperature difference that is needed for successful cooling. If the actual difference is greater than T_{Diff} then the battery cooling system enters the passive cooling mode in passive regime 71 (i.e., the controller issues command signals to position the diverter valve 43 to circulate liquid coolant from the battery cooling conduit through the radiator and to close the expansion valve feeding refrigerant to the battery chiller). In addition, the controller may activate the battery fan (e.g., based on another temperature threshold). If the actual difference is less than T_{Diff} then the battery cooling system enters the active cooling mode in active regime 72 (i.e., the controller issues command signals to position the diverter valve to circulate liquid coolant from the battery cooling conduit through the battery chiller and to open the expansion valve feeding refrigerant to the battery chiller).

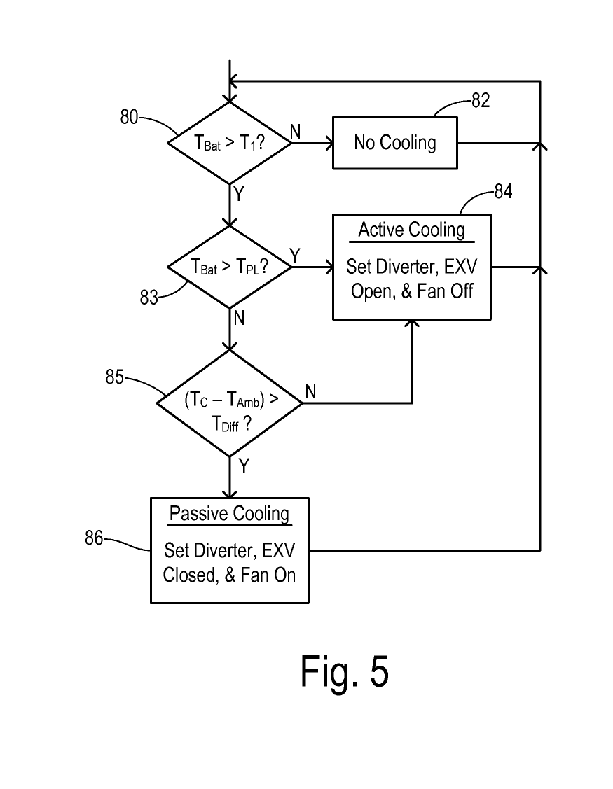

FIG. 5 shows a preferred method of the invention wherein battery temperature T_{Bat} is compared to the first threshold T₁ in step 80. If battery temperature is not greater than the first threshold T₁ then no battery cooling is needed, so a No Cooling mode is entered in step 82 and a return is made to step 80 for continuously monitoring the battery temperature. If battery temperature is greater than first threshold T₁ then battery temperature is compared to the power-limiting threshold T_{PL} in step 83. If battery temperature T_{Bat} is greater than T_{PL} then the active cooling mode is entered at step 84 wherein the diverter valve set to circulate battery coolant to the battery chiller, the EXV valve is opened, and the passive radiator fan is turned off. Then a return is made to step 80 for continuing to monitor battery temperature.

If battery temperature T_{Bat} is not greater than T_{PL} in step 83, then a difference between the battery coolant temperature T_{C} and ambient temperature T_{Amb} is compared to the difference threshold T_{Diff} in step 85. If the actual difference is not greater than the difference threshold then the active cooling mode is entered in step 84. Otherwise, the passive cooling mode can be adopted in step 86 wherein the diverter valve is set to circulate liquid coolant to the battery radiator, the EXV for the battery chiller is closed, and the blower fan for the battery radiator is turned on.

A typical air-conditioning system may utilize a variable speed compressor wherein the compressor speed is set according to the cooling load (which is usually determined by a temperature measured at the evaporator output). In the present invention, the existence of multiple evaporators together with a battery chiller wherein these elements may or may not all operate simultaneously, creates complexity for determining a compressor speed. In order to maintain acceptable cabin cooling performance without adding excess complexity to the control system, the present invention employs a priority scheme for selecting an evaporator temperature to use in determining compressor speed and adding feedforward speed bumps when the chiller is turned on. Thus, the controller sets the compressor speed according to a temperature of the main evaporator at all times when the main evaporator is cooling the passenger cabin (i.e., is actively evaporating a share of the refrigerant). As used herein, “main” evaporator refers to a front zone evaporator or a sole evaporator when there is only one zone. During times that the battery chiller is the only element actively being used to evaporate refrigerant, then the compressor speed is set by the controller according to a temperature of the battery chiller output (or the temperature of the coolant at the inlet to the battery cooling conduit). When a zone evaporator such as the rear evaporator is present for evaporating refrigerant to cool a corresponding zone in the passenger cabin, then the compressor speed is set by the controller according to a temperature of the zone evaporator whenever the zone evaporator is cooling its zone and the main evaporator is not cooling the main zone of the passenger cabin. Furthermore, the zone evaporator is given a higher priority than the battery chiller in the event that only the zone evaporator and the battery chiller are actively evaporating refrigerant.

The foregoing invention has the advantage that all three of the cooling heat exchangers have direct access to the refrigerant so that there are no losses due to intermediate heat exchangers. Furthermore, refrigerant use can be balanced between the three cooling heat exchangers to balance the necessary capacity, thereby providing advantageous energy management.

What is claimed is:

1. An electrified vehicle comprising:
an electric drive adapted to selectably move the vehicle;
a battery pack providing electrical energy to the electric drive, wherein the battery pack includes a cooling conduit for conveying a liquid coolant;
battery sensors sensing a battery temperature and a battery coolant temperature;
a passive radiator exposed to an ambient air temperature;
a liquid pump for pumping the coolant through the cooling conduit;
a shared cooling subsystem including a compressor and a condenser circulating a refrigerant;
a main evaporator selectably coupled to the shared cooling subsystem and adapted to evaporate refrigerant to cool a passenger cabin of the vehicle;
a chiller selectably coupled to the shared cooling subsystem and adapted to evaporate refrigerant to cool the coolant;
a diverting valve with a first configuration connecting the radiator with the pump and cooling conduit and a second configuration connecting the chiller with the pump and cooling conduit; and
a controller providing commands to the valve for selecting one of the configurations, wherein when the battery temperature is between a first threshold temperature and a predetermined power-limiting temperature then commanding the first configuration provided that a difference between the battery coolant temperature and the ambient temperature is greater than a predetermined difference and otherwise commanding the second configuration, and wherein when the battery temperature is greater than the power-limiting temperature then commanding the second configuration.

2. The vehicle of claim 1 further comprising a supply valve responsive to the controller to selectably couple the chiller to the shared cooling subsystem.

3. The vehicle of claim 2 wherein the supply valve is comprised of an electronic expansion valve, and wherein the controller varies a flow of refrigerant through the electronic expansion value in response to a superheat of the chiller.

4. The vehicle of claim 1 further comprising an electric fan selectably activated by the controller to blow air over the radiator when commanding the first configuration.

5. The vehicle of claim 1 wherein the compressor is a variable speed compressor, wherein the controller sets a speed of the compressor according to a temperature of the main evaporator whenever the main evaporator cools the passenger cabin, and wherein the controller sets a speed of the compressor according to a temperature of the chiller during times that refrigerant is being evaporated by only the chiller.

6. The vehicle of claim 1 further comprising:
a zone evaporator adapted to evaporate refrigerant to cool a corresponding zone within the passenger cabin; and
a supply valve responsive to the controller to selectably couple the zone evaporator to the shared cooling subsystem;
wherein the compressor is a variable speed compressor, and wherein the controller sets a speed of the compressor according to a temperature of the main evaporator whenever the main evaporator cools the passenger cabin.

7. The vehicle of claim 6 wherein the controller sets a speed of the compressor according to a temperature of the zone evaporator when the zone evaporator cools the zone and the main evaporator does not cool the passenger cabin.

8. The vehicle of claim 7 wherein the controller sets a speed of the compressor according to a temperature of the chiller during times that refrigerant is being evaporated by only the chiller.

9. The vehicle of claim 6 wherein the supply valve is comprised of a thermostatic expansion valve (TXV) and a shutoff valve.

10. A method to cool a battery in an electrified vehicle, comprising:
passively cooling the battery by circulating coolant from the battery to a radiator when a battery temperature is between a first threshold and a power threshold and a difference between a battery coolant temperature and an air temperature is greater than a predetermined difference; and
otherwise actively cooling the battery by circulating coolant from the battery to a chiller of an air conditioning system.

11. A method to cool a battery in an electrified vehicle, comprising:
actively cooling the battery by circulating coolant from the battery to a chiller of an air conditioning system when a battery temperature is above a predetermined power-limiting temperature;
passively cooling the battery by circulating coolant from the battery to a radiator when the battery temperature is between a first threshold and the power-limiting temperature and a difference between a battery coolant temperature and an ambient air temperature is greater than a predetermined difference; and
actively cooling the battery by circulating coolant from the battery to the chiller when the battery temperature is between the first threshold and the power-limiting temperature and the difference between the battery coolant temperature and the ambient air temperature is less than the predetermined difference.

12. The method of claim 11 wherein the air conditioning system includes front and rear evaporators for selectably cooling front and rear areas in a passenger cabin, wherein the air conditioning system includes a shared variable-speed compressor and condenser supplying refrigerant to the chiller and front and rear evaporators, and wherein the method further comprises:
setting a speed of the compressor according to a temperature of the front evaporator whenever the front evaporator is cooling the front area;
setting a speed of the compressor according to a temperature of the chiller whenever refrigerant from the shared compressor and condenser is being supplied only to the chiller.

13. The method of claim 12 further comprising:
setting a speed of the compressor according to a temperature of the rear evaporator whenever the rear evaporator is cooling the rear area and the front evaporator is not cooling the front area.
